(19) United States
(12) Patent Application Publication
(10) Pub. No.: US 2010/0318595 A1
(43) Pub. Date: Dec. 16, 2010

(54) System and method for conditionally transmitting one or more locum tenentes

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); Mark A. Malamud, Seattle, WA (US); William H. Mangione-Smith, Kirkland, WA (US); John D. Rinaldo, JR., Bellevue, WA (US); Clarence T. Tegreene, Bellevue, WA (US)

Correspondence Address: THE INVENTION SCIENCE FUND;CLARENCE T. TEGREENE, 11235 SE 6TH STREET, SUITE 200, BELLEVUE, WA, 98004, US

(73) Assignee: Searete LLC, a limited liability corporation of the State of Delaware

(21) Appl. No.: 12/799,794

(22) Filed: Apr. 29, 2010

Related U.S. Application Data
(63) Continuation-in-part of application No. 12/228,664, filed on Aug. 14, 2008.
Application No. 12/228,664 is a continuation-in-part of application No. 12/228,873, filed on Aug. 15, 2008.
Application No. 12/228,873 is a continuation-in-part of application No. 12/454,113, filed on May 12, 2009.

(51) Int. Cl. G06F 15/16

(52) U.S. Cl. 709/202

(57) ABSTRACT

Methods and systems are provided for receiving a conditional directive to associate one or more identified entities with one or more representative locum tenentes, and transmitting the one or more representative locum tenentes in lieu of the one or more identified entities in accordance with the conditional directive.

### RELATED APPLICATIONS

For purposes of the USPTO extra-statutory requirements, the present application constitutes a continuation-in-part of U.S. patent application Ser. No. 12/228,664, entitled System and Method for Transmitting Substitute Identification Characteristics, naming Alexander J. Cohen, Edward K. Y. Jung, Roy A. Levien, Robert W. Lord, Mark A. Malamud, William H. Mangione-Smith, John D. Rinaldo, Jr. and Casey T. Tegreene as inventors, filed Aug. 14, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/228,873, entitled System and Method for Transmitting Substitute and Non-Substitute Identification Characteristics, naming Alexander J. Cohen, Edward K. Y. Jung, Royce A. Levien, Robert W. Lord, Mark A. Malamud, William H. Mangione-Smith, John D. Rinaldo, Jr. and Clarence T. Tegreene as inventors, filed Aug. 15, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/287,268, entitled System and Method for Transmitting Illusory Identification Characteristics, naming Alexander J. Cohen, Edward K. Y. Jung, Royce A. Levien, Robert W. Lord, Mark A. Malamud, William H. Mangione-Smith, John D. Rinaldo, Jr. and Clarence T. Tegreene as inventors, filed Oct. 7, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/454,113, entitled System and Method for Modifying Illusory User Identification Characteristics, naming Alexander J. Cohen, Edward K. Y. Jung, Royce A. Levien, Robert W. Lord, Mark A. Malamud, William H. Mangione-Smith, John D. Rinaldo, Jr. and Clarence T. Tegreene as inventors, filed Oct. 7, 2008, which is currently co-pending, or is an application of which a currently co-pending application is entitled to the benefit of the filing date.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

Methods and systems are provided for associating a conditional directive with a locum tenentes.

In one aspect, a method that is executable at a machine that includes but is not limited to receiving at the machine a conditional directive to associate one or more identified entities with one or more representative locum tenentes; and transmitting the one or more representative locum tenentes in lieu of the one or more identified entities in accordance with the conditional directive. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system includes but is not limited to means for receiving at the machine a conditional directive to associate one or more identified entities with one or more representative locum tenentes; and means for transmitting the one or more representative locum tenentes in lieu of the one or more identified entities in accordance with the conditional directive. In addition to the foregoing, other system aspects are described in the claims, drawings, and text forming a part of the present disclosure.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF FIGURES

FIG. 1 shows a high-level block diagram of a system for providing a conditional directive to associate one or more identified entities with one or more representative locum tenentes.

FIG. 2 is a high-level logic flowchart of a process.

FIGS. 3A and 3B represent a high-level logic flowchart of a process.

FIGS. 4A and 4B represent a high-level logic flowchart of a process.

FIG. 5 shows a high-level block diagram of a computer program product.

FIG. 6 shows a high-level block diagram of a system for providing a conditional directive to associate one or more identified entities with one or more representative locum tenentes.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

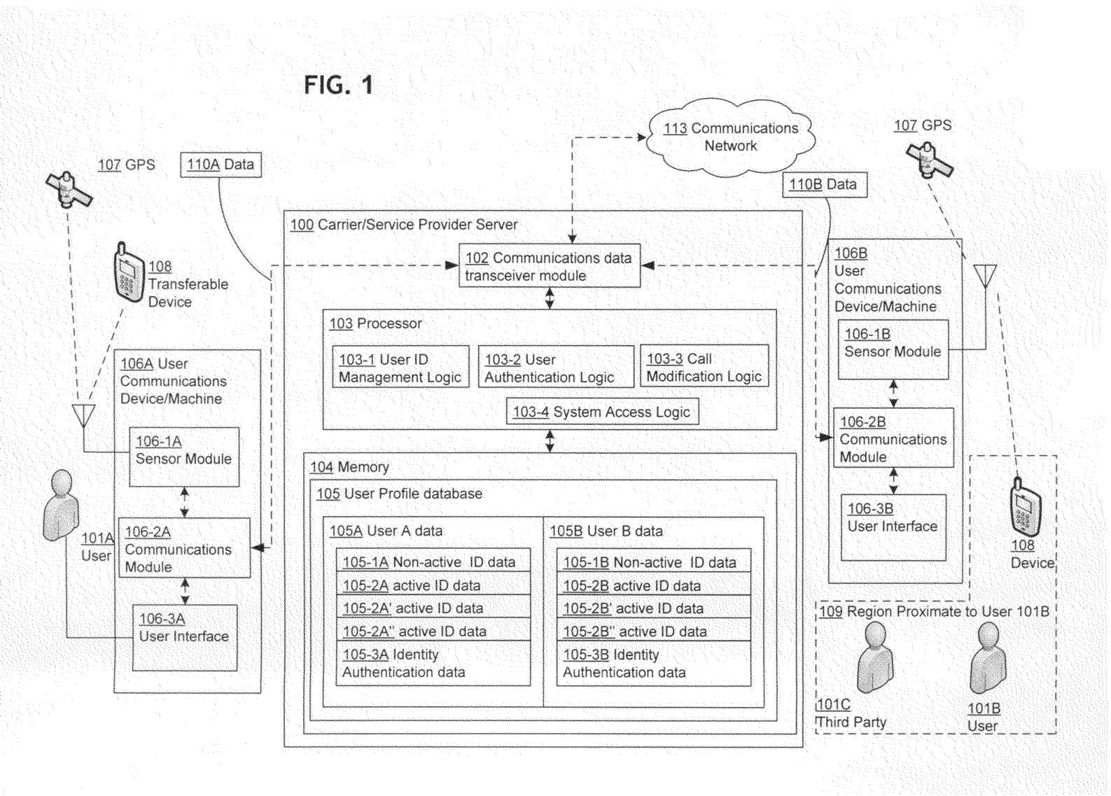

FIG. 1 illustrates an example environment in which one or more technologies may be implemented. A system for providing substitute identification characteristics may include a carrier/service provider server 100, a user communications device 106A and a user communications device 106B associated with a first user 101A and a second user 101B, respectively (e.g. subscription communications services for the first user 101A and the second user 101B that are activated on user communications device 106A and user communications device 106B respectively).

Although the first user 101A and second user 101B may be shown/described herein as a single illustrated figure, those skilled in the art will appreciate that the first user 101A and second user 101B may be representative of a human user, a robotic user (e.g., computational entity), and/or substantially any combination thereof (e.g., a user may be assisted by one or more robotic agents). The first user 101A and/or the second user 101B may include, but are not limited to, a voicemail service, a text messaging service, a web-based application service, and the like.

The carrier/service provider server 100 may be an integrated or distributed server system associated with one or more communications networks. Numerous types of communications networks 113 may be used. Examples of communications networks may include, but are not limited to, a voice over interne protocol (VoIP) network (e.g. networks maintained by Vonage®, Verizon®, Sprint®), a cellular network (e.g. networks maintained by Verizon®, Sprint®, AT&T®, T-Mobile®), a text messaging network (e.g. an SMS system in GSM), and an e-mail system (e.g. an IMAP, POP3, SMTP, and/or HTTP e-mail server), and the like.

The carrier/service provider server 100 may include a communications data transceiver module 102. Numerous types of communications data transceiver modules 102 may be used. Examples of communications data transceiver modules 102 may include, but are not limited to, a cellular transceiver, a satellite transceiver and a network portal (e.g. a modem linked to an internet service provider).

The carrier/service provider server 100 may include a processor 103. Numerous types of processors 103 may be used (e.g. general purpose processors such those marketed by Intel® and AMD, application specific integrated circuits, and the like). For example, the processor 103 may include, but is not limited to, one or more logic blocks capable of performing one or more computational functions, such as user-ID management logic 103-1, user-authentication logic 103-2, call modification logic 103-3, and/or system access logic 103-4.

The carrier/service provider server 100 may include a memory 104. Numerous types of memory 104 may be used (e.g. RAM, ROM, flash memory, and the like). The memory 104 may include, but is not limited to, a user Profile database 105 including user-ID data for one or more users (e.g. user A data 105A associated with the first user 101A and user B data 105B associated with the second user 101B). A user-ID database item for a user may include one or more fields including user identity data. For example, the user A data 105A may include Non-active ID data 105-1A, one or more active ID data (e.g. ID data 105-2A, 105-2A′, 105-2A″, etc.), and/or user identity authentication data 105-3A. The user B data 105B may include user ID data 105-1B, one or more active ID data (e.g. active ID data 105-2B, 105-2B′, 105-2B″, etc.), and/or user identity authentication data 105-3B.

The user A data 105A and/or the user B data 105B may include data representing various identified entities of one or more users, or entities that can transmit and/or receive data (e.g. first user 101A and/or second user 101B). The identified entities may include, but are not limited to, user names, identification numbers, telephone numbers (and/or area codes, international codes, and the like), images, voice prints, locations, ages, sex, gender, physical traits, business names, and the like. Such identified entities may be substituted or obfuscated (e.g. the identified entities can include one or more fictitious elements with respect to attributes of first user 101A or second user 101B) or user identification (e.g. the identified entity accurately reflects attributes of the first user 101A or second user 101B).

The first user 101A and the second user 101B may communicate using user communications device 106A and user communications device 106B, respectively. Numerous communications devices may be used. For example, the user communications device 106A and user communications device 106B may include, but are not limited to, a cell phone, satellite phone, Blackberry®, landline phone, Smartphone, a VoIP enabled device and/or computing device (e.g. a desktop or laptop computer). The user communications device 106A and user communications device 106B may include a sensor module 106-1 (e.g. sensor module 106-1A and sensor module 106-1B respectively). Numerous sensor modules may be used. For example, the sensor module 106-1A and/or sensor module 106-1B may include, but is not limited to, one or more of an image capture device (e.g. a digital camera), a microphone, a global positioning system (GPS) receiver (e.g. receiving GPS signals from GPS 107), a wireless receiver (e.g. receiving signals from transferable device 108) an electromagnetic radiation receiver and/or a biometric sensor (e.g. a voice recognition sensor, a retinal scanner and/or a fingerprint scanner).

The user communications device 106A and user communications device 106B may include a communications module 106-2 (e.g. communications module 106-2A and communications module 106-2B respectively). Numerous communications modules may be used. For example, the communications module 106-2A and/or the communications module 106-2B may include, but are not limited to, one or more of a cellular transceiver, a Bluetooth transceiver, a Wi-Fi transceiver, GPS transceiver, a satellite transceiver and a network port (e.g. a modem).

The user communications device 106A and user communications device 106B may include a user interface 106-3 (e.g. user interface 106-3A and user interface 106-3B, respectively). Numerous user interfaces may be used. For example, the user interface 106-3A and/or user interface 106-3B may include one or more of a display screen, a touch screen, a keypad, a speaker system and a microphone.

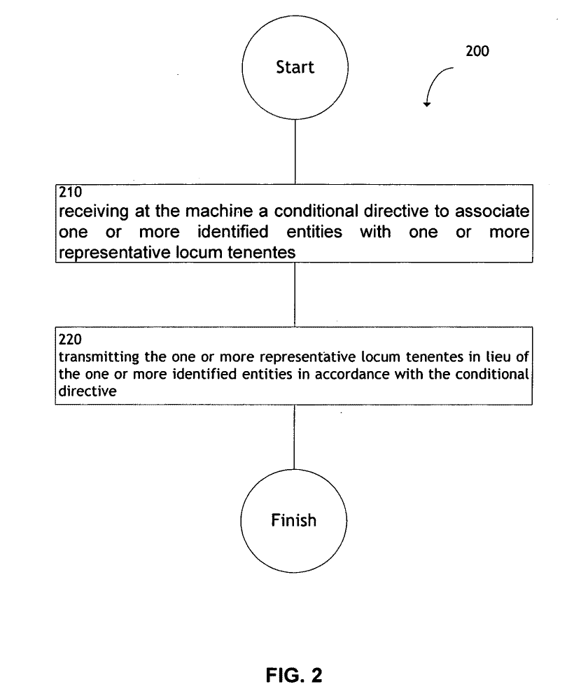

FIG. 2 illustrates an operational flow 200 representing example operations related to associating one or more identified entities with one or more representative locum tenentes. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those that are illustrated, or may be performed concurrently.

After a start operation, the operational flow 200 moves to an operation 210. Operation 210 depicts receiving at the machine a conditional directive to associate one or more identified entities with one or more representative locum tenentes. For example, as shown in FIG. 1, the communications data transceiver module 102 of the carrier/service provider server 100 may receive a conditional directive from either first user 101A or second user 101B made from a user communications device 106A or user communications device 106B to associate one or more identified entities with one or more representative locum tenentes with the first user 101A or the second user 101B. A locum tenentes in this context can include a substitute for an identified entity. An identified entity can include a user name, a user identifier, an entity that represents a specific user, and/or an entity that represents a machine associated with a user. Accordingly, a representative locum tenentes associated with an entity can include a direct substitute (e.g., a phone number substituting for user's phone number; a name substituting for user's name); or an indirect substitute (e.g., a ring tone substituting for an identification such as a name or the like).

In one example, the first user 101A may receive through a user interface 106-3A of user communications device 106A a locum tenentes whereby the carrier/service provider server 100 sends locum tenentes represented by ID data 105-2B and associated with user 101B. The locum tenentes can also include a false identification or a predetermined ring tone or the like.

In accordance with an alternate embodiment, the receiving at the machine a conditional directive to associate one or more identified entities with one or more representative locum tenentes can also include receiving the conditional directive from a machine embodied as a transferable device a conditional directive to associate one or more identified entities with one or more representative locum tenentes. For example, in a set-up mode, a user communications device 106A can send a conditional directive related to interactions with user communications device 106B that associate one or more representative locum tenentes either automatically or at a user direction. Alternatively, in an active mode, a user communications device 106A can receive a conditional directive eminating from another transferable device such as user communications device 106B.

In a set-up mode, communications module 106-2A of the user communications device 106A may transmit data 110A representing the conditional directive which may be received by the communications data transceiver module 102 of the carrier/service provider server 100. The user-ID management logic 103-1 of the processor 103 may cause the memory 104 to store data 110A representing associations of one or more identified entities with one or more representative locum tenentes to a portion of user Profile database 105 associated with a user (e.g. ID data 105-2A).

In one embodiment, server 100 includes a stored protocol in memory 104 that determines the associations of the one or more identified entities with the one or more representative locum tenentes.

Then, operation 220 depicts transmitting the one or more representative locum tenentes in lieu of the one or more identified entities in accordance with the conditional directive. For example, as shown in FIG. 1, the communications data transceiver module 102 of the carrier/service provider server 100 may transmit representative locum tenentes in accordance with a stored protocol or in accordance with stored data, such as data 110B including ID data 105-2A associated with first user 101A to a user communications device 106B associated with second user 101B. The ID data 105-2A may be received by a communications module 106-2B of the user communications device 106B and presented to the second user 101B via the user interface 106-3B of the user communications device 106B. The communications data transceiver module 102 may transmit data 110B in any number of communications data formats including, but not limited to a voice call (e.g. a landline or wireless phone call), a text message, an e-mail or a VoIP call.

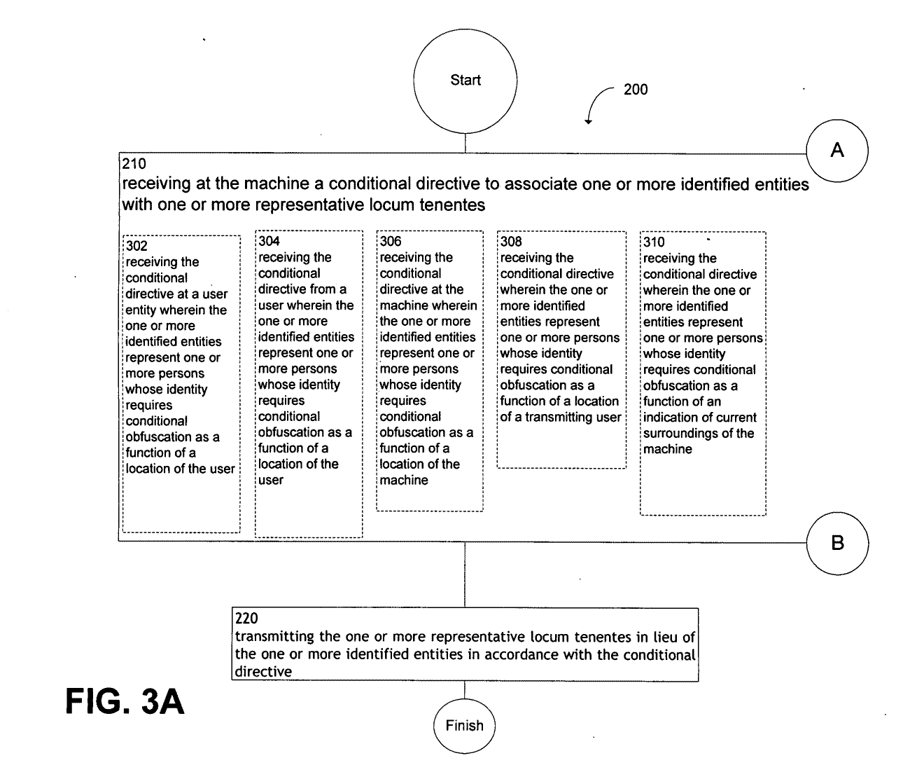

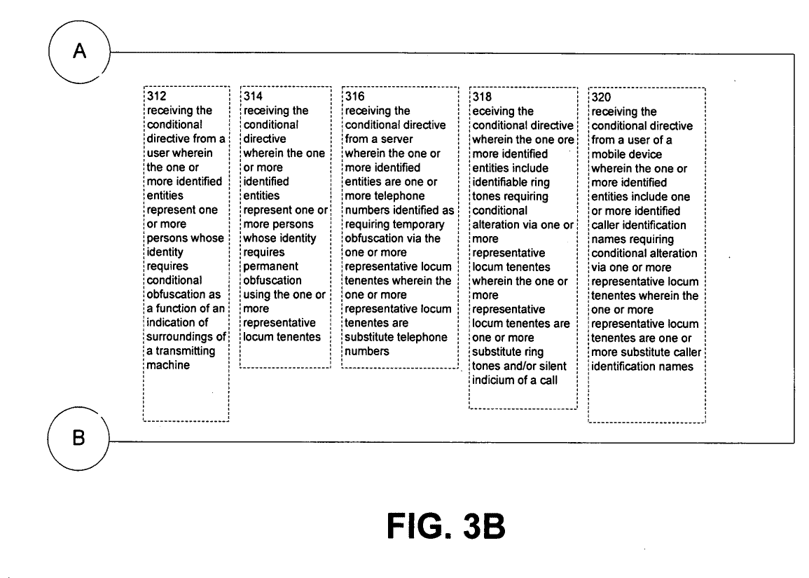

FIGS. 3A and 3B illustrate alternative embodiments of the example operational flow 200 of FIG. 2. FIGS. 3A and 3B illustrate example embodiments where the operation 210 may include at least one additional operation. Additional operations are shown in FIGS. 3A and 3B may include an operation 302, an operation 304, and/or an operation 306.

The operation 302 illustrates receiving the conditional directive at a user entity wherein the one or more identified entities represent one or more persons whose identity requires conditional obfuscation as a function of a location of the user entity. For example, as shown in FIG. 1, the carrier/service provider server 100 may send conditional directive to associate representative locum tenentes to a first user 101A having an existing user Profile database 105 file (e.g. user A data 105A). The user may have received the conditional directive from the server based on a stored protocol, from another user, such as second user 101B, or from another source. The conditional directive can include a warning that the user, based on location must transmit only representative locum tenentes. Unclear which user is which???

Alternately, the carrier/service provider server 100 may receive a request to associate one or more representative locum tenentes from a first user 101A via a user communications device 106A recognized by the carrier/service provider server 100 as belonging to a database of devices associated with known users.

The operation 302 illustrates receiving the conditional directive at a user entity wherein the one or more identified entities represent one or more persons whose identity requires conditional obfuscation as a function of a location of the user entity. For example, as shown in FIG. 1, the carrier/service provider server 100 may send to a user entity associate one or more representative locum tenentes that represent one or more persons in a manner so as to notify the user entity that obfuscation is desired. For example, a list generated based on an existing user Profile database 105 file can be received at a user entity, such as a user device. Alternately, the carrier/service provider server 100 may receive a request to associate one or more representative locum tenentes from a first user 101A via a user communications device 106A which is not recognized by the carrier/service provider server 100 as belonging to a database of devices associated with a known first user 101A. Such an unrecognized first user 101A may request carrier/service provider server 100 services on a single or limited-use basis (e.g. through use of a services calling-card) where representative locum tenentes associated with the unrecognized first user 101A identity may not be maintained in the user Profile database 105.

The operation 304 illustrates receiving the conditional directive from a user entity wherein the one or more identified entities represent one or more persons whose identity requires conditional obfuscation as a function of a location of the user entity. For example, as shown in FIG. 1, the carrier/service provider server 100 may transmit to first user 101A the conditional directive that includes identified entities, such as persons or identifiers that require obfuscation because first user 101A has entered a location. The location can be determined by global positioning, by signal strength, by pinging a nearest network location or the like. For example, first user 101A could be located at a business center where persons near to first user 101A are in a business context. In a business context, receiving or transmitting personal messages would be inappropriate. As such, the conditional directive could include identifiers of nonbusiness personal entities such that either receiving or transmitting messages related to such personal entities are obfuscated. In one embodiment, the location of the user and the location of the machine or device receiving or transmitting the one or more identified entities can be different locations.

The operation 306 illustrates receiving the conditional directive at the machine wherein the one or more identified entities represent one or more persons whose identity requires conditional obfuscation as a function of a location of the machine. For example, as shown in FIG. 1, the user communications device 106A may receive a request from carrier/service provider server 100 to obfuscate entities such as caller identification numbers that represent one or more persons based on a location of the machine. For example, as shown in FIG. 1, user communications device 106A may receive the conditional directive that includes identified entities, such as persons or identifiers that require obfuscation because a user communications device 106A has entered a location. The location can be determined by global positioning, by signal strength, by pinging a nearest network location or the like. In one embodiment, the caller identification numbers can be previously stored on user communications device 106A such that the conditional directive is received internally based on a determined location of the device. In one embodiment, a user who has been separated from a device can obfuscate all identified entities on the device. For example, if the user determines that the location of the machine is unknown, to protect the identity of potential callers to the machine, the user sends a conditional directive to user communications device 106A. An example of a conditional directive in this case could include the condition that if identified entities contact the machine, obfuscated data appears on the machine.

The operation 308 illustrates receiving the conditional directive wherein the one or more identified entities represent one or more persons whose identity requires conditional obfuscation as a function of a location of a transmitting user entity. For example, as shown in FIG. 1, the user communications device 106A may receive a conditional directive from carrier/service provider server 100 or from another user to obfuscate entities such as caller identification numbers that represent one or more persons because the transmitting user, such as user 106B, has entered a location. In an embodiment, the location entered by user 106B could be an area in which personal transmissions would be detrimental. Upon receiving the conditional directive, user 106A, in communicating with user 106B, transmits only obfuscated identity information. In one embodiment, the caller identification numbers and/or names can be previously stored on database data 110B transmitted to second user 101B by the carrier/service provider server 100 so as to disguise the user name.

The operation 310 illustrates receiving the conditional directive wherein the one or more identified entities represent one or more persons whose identity requires conditional obfuscation as a function of an indication of current surroundings of the machine. For example, as shown in FIG. 1, the user communications device 106A may receive a conditional directive from carrier/service provider server 100 to obfuscate entities such as caller identification numbers that represent one or more persons based on information that the current surroundings of user communications device 106A. An example of current surroundings includes locations determined by global positioning. For example, a home location can be stored in the user communications device 106A such that when a global positioning function on user communications device 106A determines that current surroundings are the home location, one or more identified entities are obfuscated. In one embodiment, the locations and identified entities can be previously stored as part of data 110A transmitted to/from the carrier/service provider server 100 so as to disguise the user name or entity identification of first user 101A.

The operation 312 illustrates receiving the conditional directive from a user wherein the one or more identified entities represent one or more persons whose identity requires conditional obfuscation as a function of an indication of surroundings of a transmitting machine. For example, as shown in FIG. 1, the user communications device 106A may receive a conditional directive from user communications device 106B to obfuscate entities such as caller identification numbers and data based on an indication of the surroundings of user communications device 106B. The conditional directive can eminate from user communications device 106B such that the caller identification to and/or from either device becomes obfuscated.

The operation 314 illustrates receiving the conditional directive wherein the one or more identified entities represent one or more persons whose identity requires permanent obfuscation using the one or more representative locum tenentes. For example, as shown in FIG. 1, the user communications device 106A may receive a conditional directive from carrier/service provider server 100 to permanently obfuscate entities such as caller identification numbers that represent one or more persons. The conditional directive can be set up by a user such as user 106A or can eminate from the identified entity. In one embodiment, the caller identification numbers can be stored in user profile database 105. An example of an entity to be permanently obfuscated includes parties/persons that a user desires to keep private. For example, calls from an escort service, a psychiatrist, a proctologist, a relocation service, a religious cult, and the like, could have permanent obfuscation. In one embodiment, for example, calls from an escort service can be permanently obfuscated to appear as though a family member were calling instead. The obfuscation instructions can be provided as part of data 110B transmitted to second user 101B by the carrier/service provider server 100 so as to disguise the user name of first user 101A.

The operation 316 illustrates receiving the conditional directive from a server wherein the one or more identified entities are one or more telephone numbers identified as requiring temporary obfuscation via the one or more representative locum tenentes wherein the one or more representative locum tenentes are substitute telephone numbers. For example, as shown in FIG. 1, the user communications device 106A may receive a request from carrier/service provider server 100 to obfuscate entities such as caller identification numbers that represent one or more persons. In one embodiment, the caller identification numbers can be previously stored on as part of data 110B transmitted to second user 101B by the carrier/service provider server 100 so as to disguise the user name of first user 101A.

The operation 318 illustrates receiving the conditional directive wherein the one or more identified entities include identifiable ring tones requiring conditional alteration via one or more representative locum tenentes wherein the one or more representative locum tenentes are one or more substitute ring tones and/or silent indicium of a call. For example, as shown in FIG. 1, the user communications device 106A may receive a request from carrier/service provider server 100 to obfuscate entities such as caller identification numbers that represent one or more persons. In one embodiment, the caller identification numbers can be previously stored as part of data 110B transmitted to second user 101B by the carrier/service provider server 100 so as to obfuscate the user name of first user 101A.

The operation 320 illustrates receiving the conditional directive from a user of a mobile device wherein the one or more identified entities include one or more identified caller identification names requiring conditional alteration via one or more representative locum tenentes wherein the one or more representative locum tenentes are one or more substitute caller identification names. For example, as shown in FIG. 1, the user communications device 106A may receive a request from carrier/service provider server 100 to obfuscate entities such as caller identification numbers that represent one or more persons. In one embodiment, the caller identification numbers can be previously stored as part of data 110B transmitted to second user 101B by the carrier/service provider server 100 so as to obfuscate the user name of first user 101A.

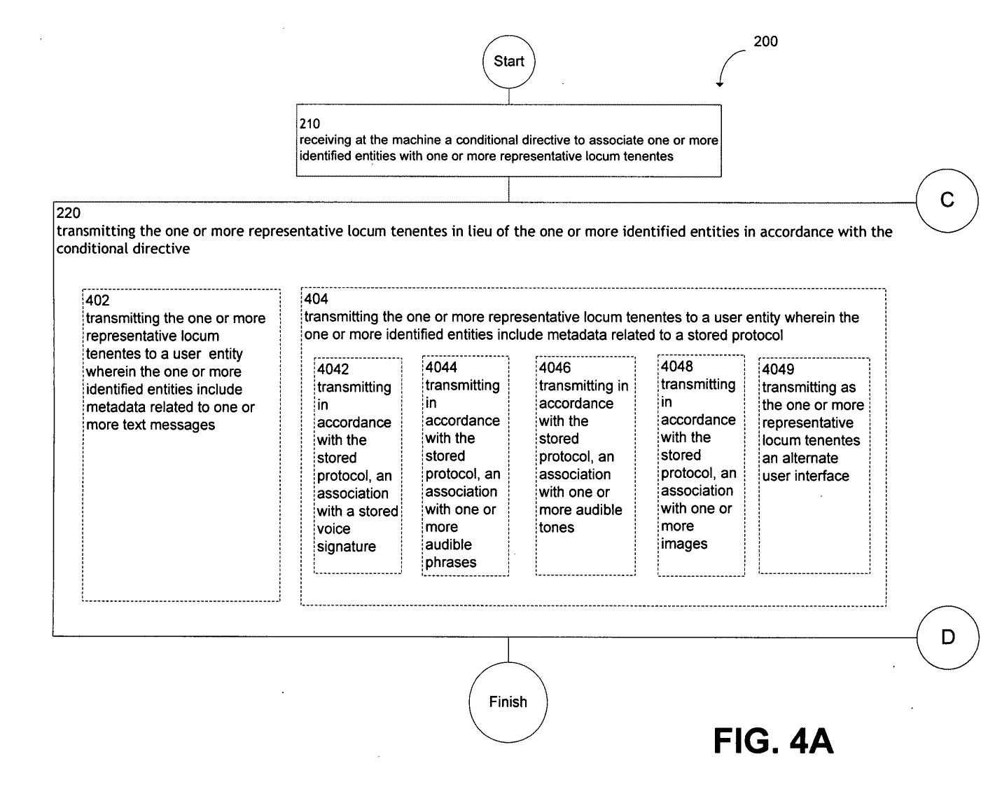

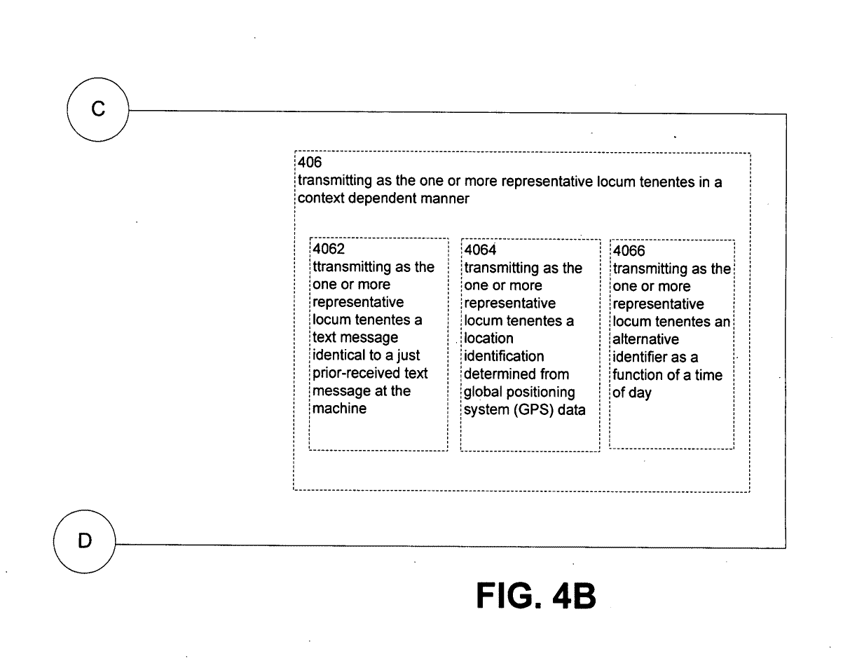

FIGS. 4A and 4B illustrate alternative embodiments of the example operational flow 200 of FIG. 2. FIGS. 4A and 4B illustrate example embodiments where the operation 220 may include at least one additional operation. Additional operations may include an operation 402, an operation 404, and/or an operation 406.

The operation 402 illustrates transmitting the one or more representative locum tenentes to a user entity wherein the one or more identified entities include metadata related to one or more text messages. For example, as shown in FIG. 1, the carrier/service provider server 100 may receive a request from first user 101A to associate an locum tenentes user identification number (e.g. a social security number) maintained as ID data 105-2A associated with first user 101A. The associated representative locum tenentes user identification number may be provided as part of data 110B transmitted to second user 101B by the carrier/service provider server 100 so as to obfuscate the user identification number of first user 101A.

The operation 404 illustrates transmitting the one or more representative locum tenentes to a user entity wherein the one or more identified entities include metadata related to a stored protocol. For example, as shown in FIG. 1, the carrier/service provider server 100 may receive a request from first user 101A to associate a representative locum tenentes user telephone number maintained as ID data 105-2A associated with first user 101A. The associated representative locum tenentes user telephone number may be provided as part of data 110B transmitted to second user 101B by the carrier/service provider server 100 so as to obfuscate the user telephone number of first user 101A. The stored protocol can include multiple options available for each identified entity such that the representative locum tenentes may change each time an identified entity changes.

Operation 404 further illustrates optional operation 4042, which includes transmitting in accordance with the stored protocol, an association with a stored voice signature. For example, first user 101A may receive the representive locum tenentes as a user voice signature (e.g. a voice signature having an altered pitch, tone, volume relative to the actual voice signature of first user 101A) maintained as ID data 105-2A associated with first user 101A. The associated representative locum tenentes may be provided as part of data 110B transmitted to second user 101B by the carrier/service provider server 100 so as to disguise the voice signature of first user 101A.

Operation 404 further includes operation 4044, transmitting in accordance with the stored protocol, an association with one or more audible phrases. For example, first user 101A may receive the representive locum tenentes as an audible phrase (e.g. a phrase “your prescription is ready” that relates to ID data 105-2A associated with user 101B). The associated representative locum tenentes may be provided as part of data 110B transmitted from second user 101B via, the carrier/service provider server 100 so as to first user 101A.

Operation 404 also includes operation 4046, which includes transmitting in accordance with the stored protocol, an association with one or more audible tones. For example, first user 101A may receive the representive locum tenentes as an audible tone (e.g. a high or low pitch tone that relates to ID data 105-2A associated with user 101B). The associated representative locum tenentes may be provided as part of data 110B transmitted from second user 101B via the carrier/service provider server 100 so as to first user 101A.

Operation 4048 which includes transmitting in accordance with the stored protocol, an association with one or more textual phrases; operation 4050 which includes transmitting in accordance with the stored protocol, an association with one or more images; and operation 4052, which includes transmitting as the one or more representative locum tenentes an alternate user interface.

As one of ordinary skill in the art with the benefit of this disclosure will appreciate, the stored protocol can include any number of representative locum tenentes, such as the stored voice signature, audible phrases, textual phrases, images and alternate user interface transmission. Each can be stored in memory 104, or in device 108. In one embodiment, the stored protocol is in one or more of user-ID management logic 103-1, call modification logic 103-3, and/or ID data 105. In one embodiment, the stored protocol identifies how many representative locum tenentes may apply to an identified entity, including a time period for altering the representative locum tenentes, such as a periodicity or the like.

The operation 406 illustrates transmitting as the one or more representative locum tenentes in a context dependent manner. For example, as shown in FIG. 1, the carrier/service provider server 100 may receive a request from first user 101A to associate a user area code (e.g. an international dialing code; country codes, city codes, cell phone codes, NANPA codes, ITU-T code, a code established under the North American Numbering Plan, and the like) maintained as ID data 105-2A associated with first user 101A. The associated representative locum tenentes can be context dependent such as determining a user area code may be provided as part of data 110B transmitted to second user 101B by the carrier/service provider server 100 so as to obufuscate the area code of first user 101A.

Disposed within operation 406 includes operation 4062 which includes transmitting as the one or more representative locum tenentes a text message identical to a just prior-received text message at the machine. For example, a user receiving an identical text message from carrier/service provider server 100. As shown in FIG. 1, the carrier/service provider server 100 in accordance with a user profile database may know generally that an identified entity is trying to reach him/her but may not know exactly which entity. When user has the opportunity, he/she can retrieve the information.

Also disposed with in operation 406 is operation 4064, which includes transmitting as the one or more representative locum tenentes a location identification determined from global positioning system (GPS) data. For example, the GPS data from GPS 107 can provide a location of user 101A such that instead of an identified entity information being transmitted, a location of the entity is transmitted. In one embodiment, the GPS data is transmitted along with another representative locum tenentes, such as a false identifier and a GPS position. “Doctor Smith, corner of Grand and Lake streets” can be transmitted for example.

Also disposed with in operation 406 is operation 4066, which includes transmitting as the one or more representative locum tenentes an alternative identifier as a function of a time of day. For example, first user 101A may receive the representive locum tenentes at noon from an identified entity with an appropriate lunch time locum tenentes (e.g., message from an escort service posing as a pizza restaurant). At another time, the locum tenentes may change to an appropriate evening locum tenentes (e.g., message from escort service posing as a pharmacy with prescriptions ready).

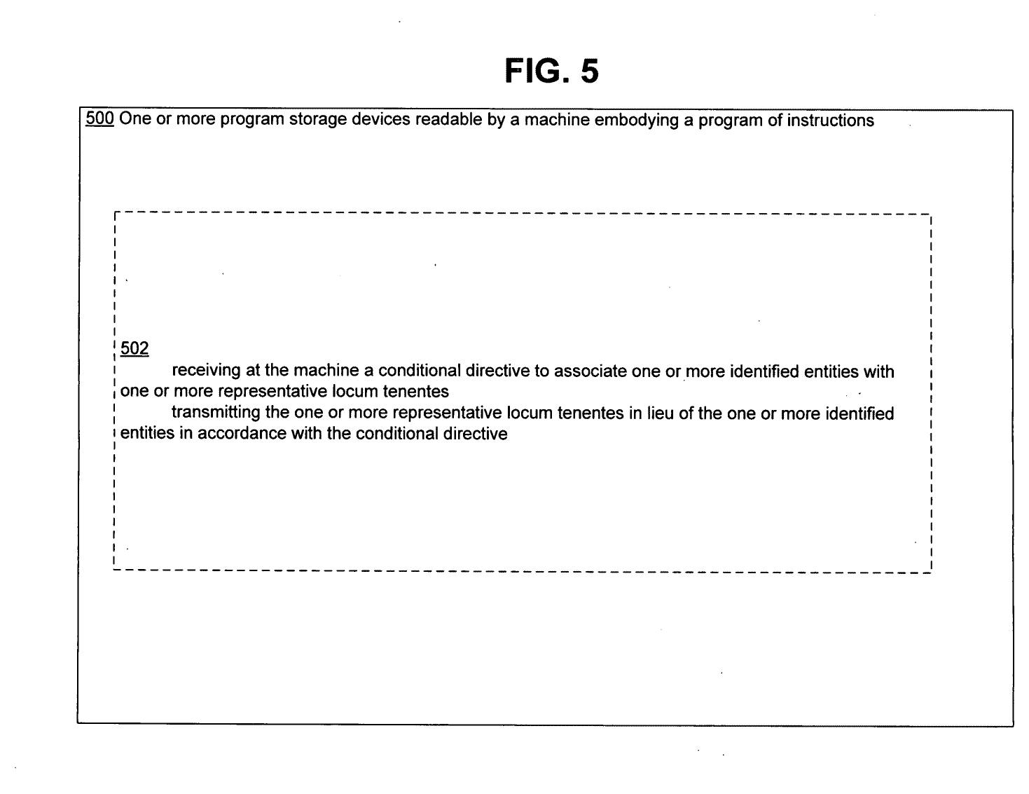

FIG. 5 illustrates a partial view of an example computer program product 500 that includes a computer program 502 for executing a computer process on a computing device.

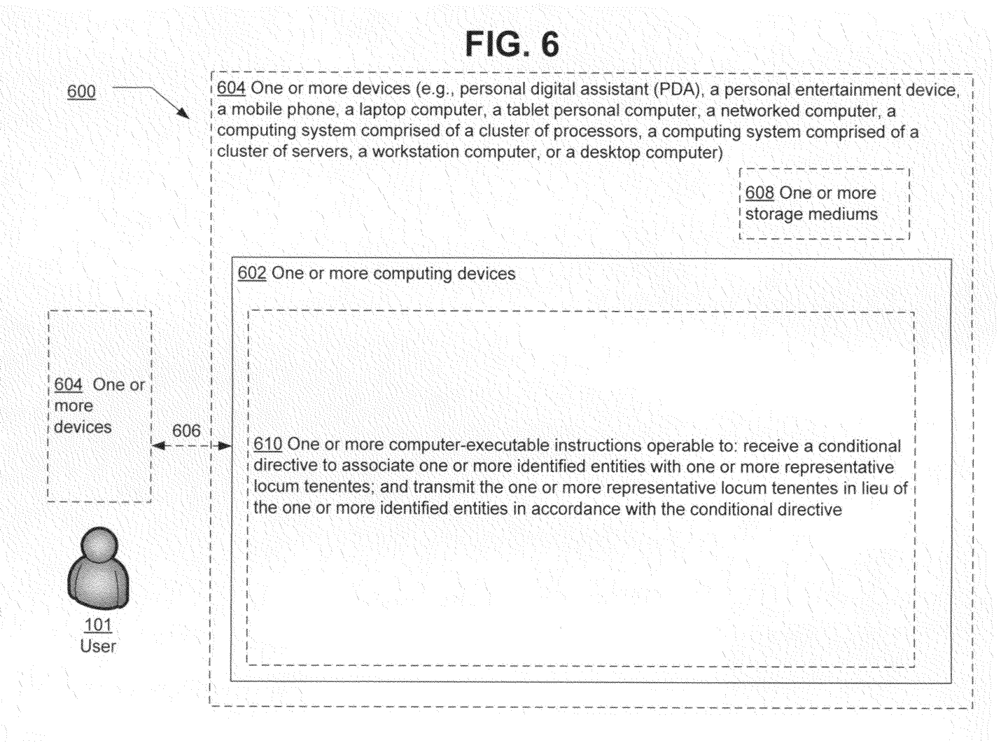

FIG. 6 illustrates an example system 600 in which embodiments may be implemented. The system 600 includes a computing system environment. The system 600 also illustrates the user 101 using a device 604, which is optionally shown as being in communication with a computing device 602 by way of an optional coupling 606. The optional coupling 606 may represent a local, wide-area, or peer-to-peer network, or may represent a bus that is internal to a computing device (e.g., in example embodiments in which the computing device 602 is contained in whole or in part within the device 604). A storage medium 608 may be any computer storage media.

The computing device 602 includes computer-executable instructions 610 that when executed on the computing device 602 cause the computing device 602 to receive a conditional directive to associate one or more identified entities with one or more representative locum tenentes and transmit the one or more representative locum tenentes in lieu of the one or more identified entities in accordance with the conditional directive. As referenced above and as shown in FIG. 6, in some examples, the computing device 602 may optionally be contained in whole or in part within the device 604.

In FIG. 6, the system 600 includes at least one computing device (e.g., 602 and/or 604). The computer-executable instructions 610 may be executed on one or more of the at least one computing device. For example, the computing device 602 may implement the computer-executable instructions 610 and output a result to (and/or receive data from) the computing device 602. Since the computing device 602 may be wholly or partially contained within the device 604, the device 604 also may be said to execute some or all of the computer-executable instructions 610, in order to be caused to perform or implement, for example, various ones of the techniques described herein, or other techniques.

The device 604 may include, for example, a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, or a desktop computer. In another example embodiment, the computing device 602 is operable to communicate with the device 604 associated with the user 101 to receive a conditional directive to associate one or more identified entities with one or more representative locum tenentes; and transmit the one or more representative locum tenentes in lieu of the one or more identified entities in accordance with the conditional directive.

Further, the device 604 may include a heterogeneous computing network including two or more of a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, or a desktop computer, operably coupled to a common computing network.

Although a user 101 is shown/described herein as a single illustrated figure, those skilled in the art will appreciate that a user 101 may be representative of a human user, a robotic user (e.g., computational entity), a business entity, a location or any of the above described identified entities and/or substantially any combination thereof (e.g., a user may be assisted by one or more robotic agents). In addition, a user 101, as set forth herein, although shown as a single entity may in fact be composed of two or more entities. Those skilled in the art will appreciate that, in general, the same may be said of “sender” and/or other entity-oriented terms as such terms are used herein.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.).

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

With respect to the appended claims, those skilled in the art will appreciate that recited operations therein may generally be performed in any order. Also, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to” or other past-tense adjectives are generally not intended to exclude such variants, unless context dictates otherwise.

Although specific dependencies have been identified in the claims, it is to be noted that all possible combinations of the features of the claims are envisaged in the present application, and therefore the claims are to be interpreted to include all possible multiple dependencies.

1. A program storage device readable by a machine, tangibly embodying a program of instructions executable by the machine to perform method steps on said machine, said method steps comprising:
receiving at the machine a conditional directive to associate one or more identified entities with one or more representative locum tenentes; and
transmitting the one or more representative locum tenentes in lieu of the one or more identified entities in accordance with the conditional directive.

2. The program storage device of claim 1, wherein the receiving at the machine a conditional directive to associate one or more identified entities with one or more representative locum tenentes includes:
receiving the conditional directive at a user entity wherein the one or more identified entities represent one or more persons whose identity requires conditional obfuscation as a function of a location of the user entity.

3. The program storage device of claim 1, wherein the receiving at the machine a conditional directive to associate one or more identified entities with one or more representative locum tenentes includes:
receiving the conditional directive from a user entity wherein the one or more identified entities represent one or more persons whose identity requires conditional obfuscation as a function of a location of the user entity.

4. The program storage device of claim 1, wherein the receiving at the machine a conditional directive to associate one or more identified entities with one or more representative locum tenentes includes:
receiving the conditional directive at the machine wherein the one or more identified entities represent one or more persons whose identity requires conditional obfuscation as a function of a location of the machine.

5. The program storage device of claim 1, wherein the receiving at the machine a conditional directive to associate one or more identified entities with one or more representative locum tenentes includes:
receiving the conditional directive wherein the one or more identified entities represent one or more persons whose identity requires conditional obfuscation as a function of a location of a transmitting user entity.

6. The program storage device of claim 1, wherein the receiving at the machine a conditional directive to associate one or more identified entities with one or more representative locum tenentes includes:
receiving the conditional directive wherein the one or more identified entities represent one or more persons whose identity requires conditional obfuscation as a function of an indication of current surroundings of the machine.

7. The program storage device of claim 1, wherein the receiving at the machine a conditional directive to associate one or more identified entities with one or more representative locum tenentes includes:
receiving the conditional directive from a user wherein the one or more identified entities represent one or more persons whose identity requires conditional obfuscation as a function of an indication of surroundings of a transmitting machine.

8. (canceled)

9. The program storage device of claim 1, wherein the receiving at the machine a conditional directive to associate one or more identified entities with one or more representative locum tenentes comprises:
receiving the conditional directive from a server wherein the one or more identified entities are one or more telephone numbers identified as requiring temporary obfuscation via the one or more representative locum tenentes wherein the one or more representative locum tenentes are substitute telephone numbers.

10. The program storage device of claim 1, wherein the receiving at the machine a conditional directive to associate one or more identified entities with one or more representative locum tenentes further comprises:
receiving the conditional directive wherein the one or more identified entities include identifiable ring tones requiring conditional alteration via one or more representative locum tenentes wherein the one or more representative locum tenentes are one or more substitute ring tones and/or silent indicium of a call.

11. The program storage device of claim 1, wherein the receiving at the machine a conditional directive to associate one or more identified entities with one or more representative locum tenentes further comprises:
receiving the conditional directive from a user of a mobile device wherein the one or more identified entities include one or more identified caller identification names requiring conditional alteration via one or more representative locum tenentes wherein the one or more representative locum tenentes are one or more substitute caller identification names.

12. The program storage device of claim 1, wherein the transmitting the one or more representative locum tenentes in lieu of the one or more identified entities in accordance with the conditional directive includes:
transmitting the one or more representative locum tenentes to a user entity wherein the one or more identified entities include metadata related to one or more text messages.

13. The program storage device of claim 12, wherein the transmitting the one or more representative locum tenentes in lieu of the one or more identified entities in accordance with the conditional directive includes:
transmitting the one or more representative locum tenentes to a user entity wherein the one or more identified entities include metadata related to a stored protocol.

14. The program storage device of claim 13, wherein the transmitting the one or more representative locum tenentes to a user entity wherein the one or more identified entities include metadata related to a stored protocol comprises:
transmitting in accordance with the stored protocol, an association with a stored voice signature.

15. The program storage device of claim 13, wherein the transmitting the one or more representative locum tenentes to a user entity wherein the one or more identified entities include metadata related to a stored protocol comprises:
transmitting in accordance with the stored protocol, an association with one or more audible phrases.

16. The program storage device of claim 13, wherein the transmitting the one or more representative locum tenentes to a user entity wherein the one or more identified entities include metadata related to a stored protocol comprises:
transmitting in accordance with the stored protocol, an association with one or more audible tones.

17. The program storage device of claim 13, wherein the transmitting the one or more representative locum tenentes to a user entity wherein the one or more identified entities include metadata related to a stored protocol comprises:
transmitting in accordance with the stored protocol, an association with one or more textual phrases.

18. The program storage device of claim 13, wherein the transmitting the one or more representative locum tenentes to a user entity wherein the one or more identified entities include metadata related to a stored protocol comprises:
transmitting in accordance with the stored protocol, an association with one or more images.

19. The program storage device of claim 13, wherein the transmitting the one or more representative locum tenentes to a user entity wherein the one or more identified entities include metadata related to a stored protocol comprises:
transmitting as the one or more representative locum tenentes an alternate user interface.

20. The program storage device of claim 1, wherein the transmitting the one or more representative locum tenentes in lieu of the one or more identified entities in accordance with the conditional directive includes:
transmitting as the one or more representative locum tenentes in a context dependent manner.

21. The program storage device of claim 20, wherein the transmitting as the one or more representative locum tenentes in a context dependent manner includes:
transmitting as the one or more representative locum tenentes a text message identical to a just prior-received text message at the machine.

22. The program storage device of claim 20, wherein the transmitting as the one or more representative locum tenentes in a context dependent manner includes:
transmitting as the one or more representative locum tenentes a location identification determined from global positioning system (GPS) data.

23. The program storage device of claim 20, wherein the transmitting as the one or more representative locum tenentes in a context dependent manner includes:
transmitting as the one or more representative locum tenentes an alternative identifier as a function of a time of day.

24. A system comprising:
a memory; and
a processor coupled to the memory, the processor including:
means for receiving a conditional directive to associate one or more identified entities with one or more representative locum tenentes; and
means for transmitting the one or more representative locum tenentes in lieu of the one or more identified entities in accordance with the conditional directive.

25. The system of claim 24, wherein the means for receiving a conditional directive to associate one or more identified entities with one or more representative locum tenentes includes:
means for receiving the conditional directive at a user entity wherein the one or more identified entities represent one or more persons whose identity requires conditional obfuscation as a function of a location of the user entity.

26. The system of claim 24, wherein the means for receiving a conditional directive to associate one or more identified entities with one or more representative locum tenentes includes:
means for receiving the conditional directive from a user entity wherein the one or more identified entities represent one or more persons whose identity requires conditional obfuscation as a function of a location of the user entity.

27. The system of claim 24, wherein the means for receiving a conditional directive to associate one or more identified entities with one or more representative locum tenentes includes:
means for receiving the conditional directive at the machine wherein the one or more identified entities represent one or more persons whose identity requires conditional obfuscation as a function of a location of the machine.

28. The system of claim 24, wherein the means for receiving at the machine a conditional directive to associate one or more identified entities with one or more representative locum tenentes includes:
means for receiving the conditional directive wherein the one or more identified entities represent one or more persons whose identity requires conditional obfuscation as a function of a location of a transmitting user entity.

29. The system of claim 24, wherein the means for receiving at the machine a conditional directive to associate one or more identified entities with one or more representative locum tenentes includes:
means for receiving the conditional directive wherein the one or more identified entities represent one or more persons whose identity requires conditional obfuscation as a function of an indication of current surroundings of the machine.

30. The system of claim 24, wherein the means for receiving at the machine a conditional directive to associate one or more identified entities with one or more representative locum tenentes includes:
means for receiving the conditional directive from a user wherein the one or more identified entities represent one or more persons whose identity requires conditional obfuscation as a function of an indication of surroundings of a transmitting machine.

31. (canceled)

32. The system of claim 24, wherein the means for receiving at the machine a conditional directive to associate one or more identified entities with one or more representative locum tenentes comprises:
means for receiving the conditional directive from a server wherein the one or more identified entities are one or more telephone numbers identified as requiring temporary obfuscation via the one or more representative locum tenentes wherein the one or more representative locum tenentes are substitute telephone numbers.

33. The system of claim 24, wherein the means for receiving at the machine a conditional directive to associate one or more identified entities with one or more representative locum tenentes further comprises:
means for receiving the conditional directive wherein the one or more identified entities include identifiable ring tones requiring conditional alteration via one or more representative locum tenentes wherein the one or more representative locum tenentes are one or more substitute ring tones and/or silent indicium of a call.

34. The system of claim 24, wherein the means for receiving at the machine a conditional directive to associate one or more identified entities with one or more representative locum tenentes further comprises:
means for receiving the conditional directive from a user of a mobile device wherein the one or more identified entities include one or more identified caller identification names requiring conditional alteration via one or more representative locum tenentes wherein the one or more representative locum tenentes are one or more substitute caller identification names.

35. The system of claim 24, wherein the means for transmitting the one or more representative locum tenentes in lieu of the one or more identified entities in accordance with the conditional directive includes:
means for transmitting the one or more representative locum tenentes to a user entity wherein the one or more identified entities include metadata related to one or more text messages.

36. The system of claim 35, wherein the means for transmitting the one or more representative locum tenentes in lieu of the one or more identified entities in accordance with the conditional directive includes:
means for transmitting the one or more representative locum tenentes to a user entity wherein the one or more identified entities include metadata related to a stored protocol.

37. The system of claim 36, wherein the means for transmitting the one or more representative locum tenentes to a user entity wherein the one or more identified entities include metadata related to a stored protocol comprises:
means for transmitting in accordance with the stored protocol, an association with a stored voice signature.

38. The system of claim 36, wherein the means for transmitting the one or more representative locum tenentes to a user entity wherein the one or more identified entities include metadata related to a stored protocol comprises:
means for transmitting in accordance with the stored protocol, an association with one or more audible phrases.

39. The system of claim 36, wherein the means for transmitting the one or more representative locum tenentes to a user entity wherein the one or more identified entities include metadata related to a stored protocol comprises:
means for transmitting in accordance with the stored protocol, an association with one or more audible tones.

40. The system of claim 36, wherein the means for transmitting the one or more representative locum tenentes to a user entity wherein the one or more identified entities include metadata related to a stored protocol comprises:
means for transmitting in accordance with the stored protocol, an association with one or more textual phrases.

41. The system of claim 36, wherein the means for transmitting the one or more representative locum tenentes to a user entity wherein the one or more identified entities include metadata related to a stored protocol comprises:
means for transmitting in accordance with the stored protocol, an association with one or more images.

42. The system of claim 36, wherein the means for transmitting the one or more representative locum tenentes to a user entity wherein the one or more identified entities include metadata related to a stored protocol comprises:
means for transmitting as the one or more representative locum tenentes an alternate user interface.

43. The system of claim 24, wherein the means for transmitting the one or more representative locum tenentes in lieu of the one or more identified entities in accordance with the conditional directive includes:
means for transmitting as the one or more representative locum tenentes in a context dependent manner.

44. The system of claim 43, wherein the means for transmitting as the one or more representative locum tenentes in a context dependent manner includes:
means for transmitting as the one or more representative locum tenentes a text message identical to a just prior-received text message at the machine.

45. The system of claim 43, wherein the means for transmitting as the one or more representative locum tenentes in a context dependent manner includes:
means for transmitting as the one or more representative locum tenentes a location identification determined from global positioning system (GPS) data.

46. The system of claim 43, wherein the means for transmitting as the one or more representative locum tenentes in a context dependent manner includes:
means for transmitting as the one or more representative locum tenentes an alternative identifier as a function of a time of day.

47. A system comprising:
a computing device; and
instructions that when executed on the computing device cause the computing device to:
receive at the computing device a conditional directive to associate one or more identified entities with one or more representative locum tenentes; and
transmit the one or more representative locum tenentes in lieu of the one or more identified entities in accordance with the conditional directive.

48. The system of claim 47, wherein the computing device comprises:
one or more of a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, and/or a desktop computer.
